(19) United States
(12) Patent Application Publication
(10) Pub. No.: US 2006/0178904 A1
(43) Pub. Date: Aug. 10, 2006

(54) Interactive system that is useful in cosmetics and a method of building a database

(75) Inventors: Fabrice Aghassian, Paris (FR); Catherine Donnart, Clamart (FR)

Correspondence Address: OLIFF & BERRIDGE, PLC, P.O. BOX 19928, ALEXANDRIA, VA, 22320, US

(73) Assignee: L'OREAL, PARIS (FR)

(21) Appl. No.: 11/346,392

(22) Filed: Feb. 3, 2006

Related U.S. Application Data
(60) Provisional application No. 60/652,740, filed on Feb. 15, 2005.

(30) Foreign Application Priority Data
Feb. 4, 2005 (FR) 05 01148

(51) Int. Cl. G06Q 99/00

(52) U.S. Cl. 705/1

(57) ABSTRACT

An interactive system for advising at least one person may be configured to acquire at least one estimated or measured appearance characteristic of a person to be advised. The system may: interrogate a database, the database including information relating to appearance characteristics desired by a reference population as a function of appearance characteristics estimated or measured amongst the individuals of the reference population; and, at least by interrogating the database, as a function of the at least one estimated or measured appearance characteristic, gather information from the database relative to a desired appearance characteristic desired by at least one section of the reference population. The system may also send information to the at least one person to be advised, the information relating to the desired appearance characteristic and/or relating to at least one cosmetic for obtaining the desired appearance characteristic.

This non provisional application claims the benefit of French Application No. 05 01148 filed on Feb. 4, 2005 and U.S. Provisional Application No. 60/652,740 filed on Feb. 15, 2005.

The present invention relates to interactive methods and systems used in cosmetics for informing and/or advising consumers.

### BACKGROUND

U.S. Pat. No. 4 160 271 discloses a device including a keyboard enabling the consumer to enter information relating to the consumer's complexion and skin type, and in return said device delivers information that can assist the consumer in choosing a suitable cosmetic.

European patent application EP 1 240 845 describes a device that makes it possible to provide personalized advice with regard to hair color. From data provided by the user and from stored data, that device determines the kinds of color results that can be achieved, and recommends to the user cosmetics or sets of cosmetics selected from cosmetics listed in its data.

### SUMMARY

A need exists to improve still further interactive advice or cosmetic-recommendation systems in order to assist the consumer in making a choice.

Amongst other things, the invention may obviate this need by means of an interactive system comprising:
acquisition means for acquiring at least one estimated or measured appearance characteristic of a person to be advised;
as a function of the appearance characteristic acquired in this way of the person to be advised, data management means making it possible, at least by interrogating a database, to gather information relating to an appearance characteristic desired by at least one section of a reference population, the database listing information relating to appearance characteristics desired by the reference population as a function of appearance characteristics estimated or measured amongst the individuals constituting the reference population; and
means for sending information to the person to be advised, said information relating to the desired appearance characteristic determined in this way by the data management means and/or relating to at least one cosmetic for obtaining the desired appearance characteristic.

In an embodiment of the invention, the above-mentioned section of the reference population is the section made up of individuals that present substantially the same appearance characteristic as the person to be advised.

The term “appearance characteristic” should be understood as a characteristic that is associated with the appearance of the person to be advised, e.g. natural skin color, hair color, and/or style of dress of the person. Where appropriate, the appearance characteristic may be deduced from the trade reference of a cosmetic having a color that corresponds to the skin or the hair color of the user, for example. In this event, instead of entering a color directly, the user can give the reference of the cosmetic used.

The invention may make it possible to deliver advice and/or to propose or recommend a cosmetic and/or a treatment, in particular a non-therapeutic treatment, on the basis of at least one statistical observation made in the reference population.

By way of example, the reference population is characterized by belonging to a particular ethnic group, or by geographical location (e.g. country, region, or neighborhood in a town), or by particular habits, e.g. shopping in a store or in a given chain of stores.

By way of example, the invention may make it possible to recommend one or more cosmetics in more targeted manner, or to encourage the consumer in the choice of cosmetic or to suggest cosmetics that are more likely to be selected.

The invention also provides a method which may make it possible to deliver a cosmetic recommendation and/or personalized advice, the method comprising:
enabling an interactive system, e.g. as defined above, to acquire information relating to a personal characteristic of the person to be advised;
interrogating a database that lists the trends, in the field of cosmetics, observed in a reference population as a function of the personal characteristics of the individuals making up the reference population; and
as a function of the result of the interrogation, delivering, via the interactive system, information informing the user of a trend observed in the reference population for individuals of said reference population, e.g. for individuals having a similar personal characteristic.

By way of example, the personal characteristic is an appearance characteristic, e.g. relating to the skin or the hair, or it is a characteristic that is not associated with appearance, e.g. associated with the user's tastes with regard to music, cinema, leisure, etc.

By way of example, the user can enter information relating to an appearance characteristic, and information relating to a personal characteristic other than an appearance characteristic.

The invention also provides a method of building a database, the method comprising:
recording for each individual of a reference population:
   at least one personal characteristic, e.g. an appearance characteristic; and
   at least one desired appearance characteristic, e.g. a desired skin or hair color after a cosmetic has been applied; and
statistically processing the data recorded in this way, so as to reveal trends in desired appearance characteristics as a function of personal characteristics.

By way of example, the individuals making up the reference population may be the inhabitants of a given country, or people living in a more restricted geographical area, e.g. a region, or even more restricted, e.g. the inhabitants of a town or neighborhood in a town.

Such a method makes it possible to reduce the number of different cosmetics that are made available locally to consumers, by eliminating a range, e.g. those that do not correspond to the observed trends.

By way of example, the trend that is looked for is the general trend observed in the section of the reference population made up of individuals who present a personal characteristic similar to the personal characteristic of the individual to be advised or informed.

It is also possible to seek to reveal all of the trends, or the most representative trends, that are observed amongst individuals having a personal characteristic similar to the personal characteristic of the individual to be advised or informed.

The database can also be useful in a method of marketing a range of cosmetics, in which the only cosmetics offered for sale are those that make it possible to obtain the changes in the appearance characteristics that correspond to trends identified in the database and followed by a significant proportion of the population, e.g. greater than a predefined threshold, e.g. at least 2%, or indeed 5%.

The acquisition means of the interactive system may comprise at least one measuring device for measuring a physical, chemical, and/or biological characteristic of keratinous materials, e.g. a measuring device for measuring the color of the skin or of the hair.

By way of example, the acquisition means may comprise a camera and calorimetric calibration means for colorimetric calibration of said camera in order to make a color measurement that is accurate.

Where appropriate, the camera may be associated with a light source for illuminating the region to be observed.

The acquisition means may comprise a user interface such as, for example: at least one of a keyboard; a touch-sensitive screen; a mouse; a voice recognition device; or a modem or receiver for receiving data sent from a remote terminal via a computer and/or telephone network.

By way of example, the information relating to the appearance characteristic of the user may thus be communicated to the interactive system by responding to a questionnaire, and by specifying an identifier taken from a color chart, or the trade reference of a cosmetic that is used and that is assumed to correspond to the skin or hair color of the user.

The acquisition means may be arranged to enable a measurement to be made at a point of sale or elsewhere, e.g. at home.

By way of example, the means for sending information to the person to be advised may include a display device such as a screen, e.g. a liquid crystal, plasma, cathode ray tube (CRT), or light-emitting diode (LED) screen. The information may also be sent by some other means, e.g. by a voice message, or by sending a computer file, e.g. by e-mail, by short message service (SMS), by multimedia messaging service (MMS), or the like, or by post.

The interactive system may include at least one physical comparison element that enables the user or an assistant to evaluate an appearance characteristic, e.g. a skin-color chart, a hair-color chart, or an atlas representing various graduations of some characteristic of the body.

The physical comparison elements may optionally be secured to the data management means or to the acquisition means.

When the interactive system is present at a point of sale, for example, the comparison element(s) is/are preferably secured to the interactive system.

However, when the interactive system is used via an Internet site, for example, the comparison elements could be independent, and they could, for example, be in the form of an evaluation kit or accessory, or in the form of information on the packaging or the instructions of a cosmetic.

In the absence of physical comparison elements, or in addition to said elements, one or more virtual comparison elements can be presented to the consumer or to an assistant by means of the above-mentioned display device, for example, or by means of some other display means.

When the interactive system includes a color chart, each color sample of said color chart is preferably produced so that its reflectance spectrum substantially reproduces the reflectance spectrum of a keratinous element that was used as a reference. The color chart can thus be used regardless of different lighting conditions, such as daylight or artificial light, for example.

In an exemplary embodiment of the invention, the interactive system may make it possible to record data relating to the cosmetics purchased by people who have used the interactive system. Where appropriate, this enables the database to be enriched, and enables additional information to be delivered to future users, helping them in making their choices.

The interactive system may include issuing means for issuing an advice slip relating to the recommended cosmetic(s), and it may be arranged to receive information that can be read at a cash desk, and that is present on such an advice slip, the information received being associated with at least one reference for a cosmetic that has actually been purchased by the user. It is thus possible to know whether the user has purchased the cosmetic that was recommended, and whether the user has also purchased any other cosmetic.

The data management means may be arranged to recommend one or more colors to the user, the colors corresponding to appearance characteristics desired by the reference population, and the interactive system may be arranged to enable the user to select one of said colors. A cosmetic can then be recommended to the user that enables the selected color to be obtained, for example.

The data management means may be arranged to recommend one or more cosmetics to the user, the cosmetics serving to obtain colors corresponding to appearance characteristics desired by the reference population, and the interactive system may be arranged to enable the user to select one of said cosmetics.

As a function of the difference between an estimated or measured appearance characteristic of the person to be advised and the desired appearance characteristic corresponding to a trend observed in the reference population, the data management means of the interactive system may be arranged to determine at least one cosmetic to be applied. The cosmetic may be an existing cosmetic, with the trade reference of the cosmetic being recommended to the user, for example. The cosmetic may also be personalized, e.g. being prepared at the place of sale, or remotely and then sent to the consumer.

The interactive system advantageously includes means for recording an appearance characteristic desired by the user, before and/or after said user has been informed of at least one desired appearance characteristic corresponding to at least one trend observed in the reference population. This enables the database to be enriched still further.

The data management means and the acquisition means may be geographically close together, or they may be geographically remote. Where appropriate, the information relating to the appearance characteristic acquired by the acquisition means may be sent via a computer network, in particular the Internet, to the data management means.

Independently or in combination with the above, the invention also provides a method for delivering advice or a recommendation relating to a cosmetic for changing an appearance characteristic of a subject, the method comprising:

a) acquiring information that is representative of the appearance characteristic of the subject to be advised; and

b) delivering information that is representative of an appearance characteristic change that is desired by at least one section of a reference population.

By way of example, the appearance characteristic is the color of the skin or of the hair.

### BRIEF DESCRIPTION OF THE DRAWINGS

The invention can be better understood on reading the following detailed description of non-limiting embodiments thereof, and on examining the accompanying drawings, in which:

FIG. 1 is a diagrammatic perspective view of an example of an interactive system made in accordance with the invention;

FIG. 2 shows a color-measuring device in isolation;

FIG. 3 shows facial skin color being acquired by means of the FIG. 2 device;

FIG. 4 is a block diagram showing various steps of a method constituting an implementation of the invention;

FIG. 5 is a diagram showing various trends observed in a reference population;

FIGS. 6 and 7 are diagrams of data tables;

FIGS. 8 to 13 and 15 to 19 show various screen pages that can be displayed by the display device of the interactive system during implementations of the invention;

FIG. 14 is a diagram of an advice slip;

FIGS. 20 to 24 show trends observed with regard to hair;

FIG. 25 shows an interactive system used in connection with means that make it possible to receive purchasing data;

FIG. 26 is a view similar to FIG. 1 of a variant of an interactive system; and

FIG. 27 shows an interactive system including a remote server.

### MORE DETAILED DESCRIPTION

The interactive system 1 shown in FIG. 1 comprises: data management means, e.g. such as a micro-computer or the like (e.g. an electronics card or circuit having one or more micro-controllers or micro-processors) that is not visible since it is housed in a stand 2, for example; a display device 3, e.g. such as a flat screen; acquisition means 4, e.g. comprising a keyboard connected to data management means; and issuing means for issuing an advice slip 6, said issuing means being constituted by a printer, for example, that is not shown since it is housed in the stand 2.

By way of example, the interactive system 1 is present at a point of sale or in a beauty salon, and can optionally operate on its own. When the interactive system 1 is not operating on its own, the data management means can exchange information with a remote server, e.g. via the Internet network or via an Intranet network.

In the embodiment in FIG. 1, the interactive system 1 further comprises comparison elements constituting a color chart 5 that enables a user to evaluate skin color visually.

By way of example, each comparison element of the color chart 5 is associated with an identifier, thereby enabling the user to communicate a skin color to the data management means by entering the corresponding identifier via the keyboard 4.

The information can also be sent to the data management means via some other means, e.g. by providing the color chart with sensor means, or by wireless transmission by means of a telephone or some other mobile terminal.

The comparison elements of the color chart are preferably produced so as to reproduce substantially the reflectance spectrum of the skin, seeking to imitate its color, so as to enable an accurate evaluation to be made regardless of the type of lighting. On this topic, the person skilled in the art can usefully refer to U.S. patent application Ser. No. 10/006886, the contents of which are incorporated herein by reference.

The color chart 5 can be replaced by other physical comparison elements such as a hair-color chart or an atlas, for example, or by virtual comparison elements displayed on the display device 3. In particular, the display device can display a color chart, or images, or videos enabling the user to evaluate an appearance characteristic.

In a variant of the invention, the interactive system 1 includes a device that makes it possible to perform a physical, chemical, and/or biological measurement on the user, e.g. a measurement of the color and/or the shine of the skin or of the hair.

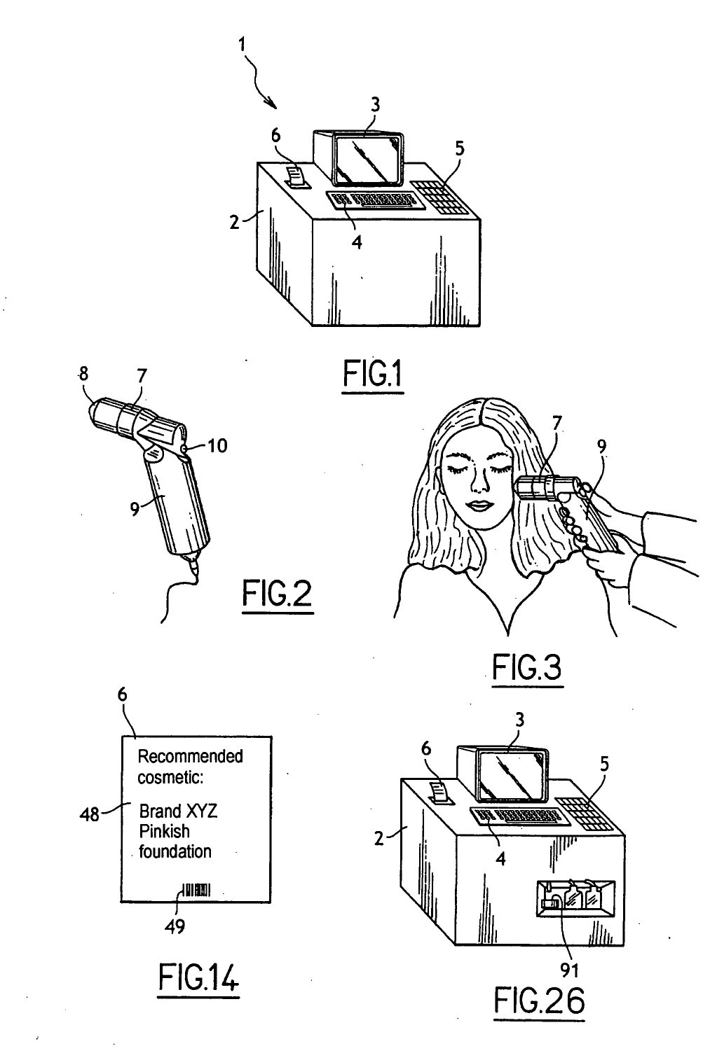

By way of example, FIG. 2 shows a measuring device 7 for measuring the color of the skin, said device comprising, for example, a measuring window 8 for placing against the skin or in front of said skin, a handle 9, and a control button 10 enabling the user to take the measurement, as shown in FIG. 3.

In this figure, the measurement is taken by an assistant, but it is not beyond the ambit of the present invention for the interactive system 1 to be used by the consumer alone, at a point of sale, at home, or elsewhere.

When the measuring device is arranged to measure hair color, the device can, if necessary, be arranged to distinguish gray hairs from other hairs, for example, prior to determining the color of the non-gray hairs.

In a variant, not shown, the interactive system 1 can also include acquisition means for acquiring at least one digital image of the person to be advised, e.g. the person's face, and the color of the skin can, for example, be measured at several locations on the face by processing the image.

By way of example, the acquisition can be performed by means of a digital camera or a video camera. Colorimetric calibration means can be placed in the field of view of the camera. On this topic, the person skilled in the art can usefully refer to U.S. Pat. No. 6,362,849, the contents of which are incorporated herein by reference.

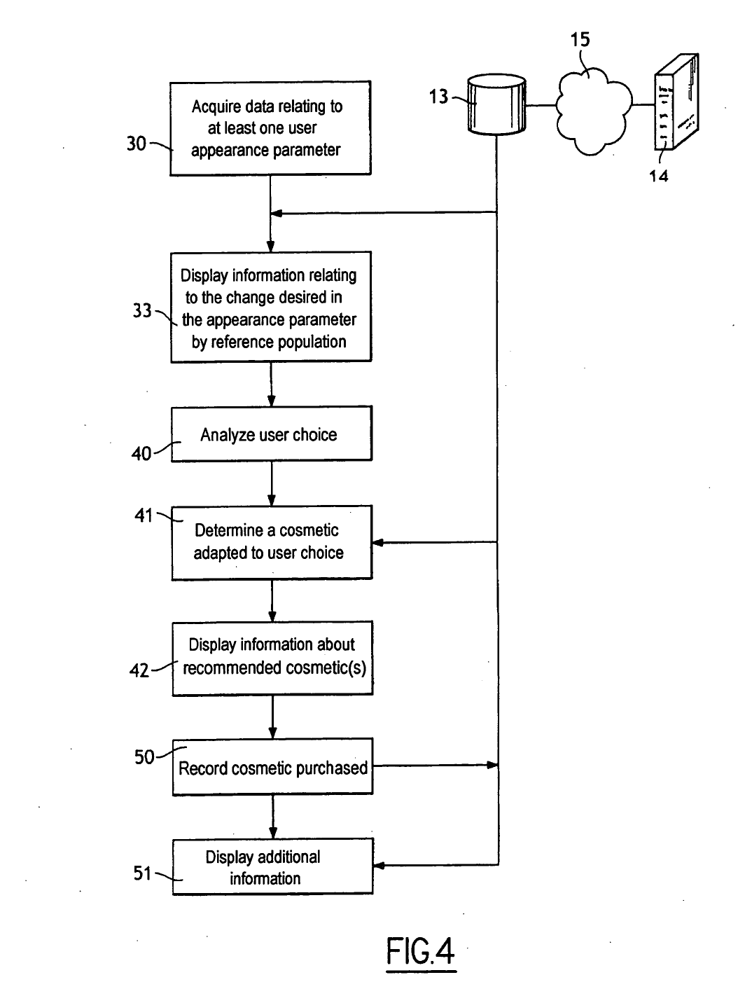

FIG. 4 is a diagram showing a database 13 of the interactive system 1, and shows various steps of a method constituting an implementation of the invention that is capable of making use of the data contained in said database.

The database 13 can be arranged to be updated regularly, e.g. by exchanging data with a server 14, with data being exchanged via a telephone network and/or computer network 15, in particular the Internet network or an Intranet network.

The database 13 can optionally be geographically close to the rest of the interactive system, and in the event of the database 13 being geographically remote, the data management means can be arranged to establish a telephone and/or computer connection with the database.

When the database 13 is geographically located at the same location as the rest of the interactive system, the database 13 is, for example, recorded on the hard disk and/or in a memory of a micro-computer to which the data management means also belong.

In an aspect of the invention, the database 13 contains information that is statistically representative of trends that are observed in a reference population, indeed in a plurality of reference populations satisfying certain distinct criteria, e.g. geographical criteria.

In particular, the trends can consist of desired appearance characteristics, e.g. desired skin colors, as a function of appearance characteristics estimated or measured amongst the individuals of a reference population, in particular the estimated or measured skin colors of the individuals.

By way of example, a reference population corresponds to a population living in a certain geographical area, and the trend that is observed could equally well reflect an old trend that is well established in people's minds as it could reflect a passing fashion phenomenon.

By way of illustration, FIG. 5 shows examples of trends observed amongst the individuals of a reference population having skin colors that are different from one another.

In the examples in this figure, the trends can be represented by vectors on a plane having an X-axis that corresponds to the clarity of the skin of the individuals, e.g. the clarity estimated by said individuals, and having a Y-axis that corresponds to the hue of the skin color, e.g. the hue estimated by said individuals.

A point or a zone on the plane in FIG. 5 corresponds to individuals having given clarity and hue, which in this embodiment are estimated, but which could, in a variant, be measured, and the skin colors desired by such individuals have been collected.

A vector on the plane in FIG. 5 represents a trend that is observed amongst those individuals having clarity and hue that correspond to the origin of the vector.

Statistically, and by way of example, the observed trend is the general trend corresponding to the average of the desired variations for all of the consulted individuals defining the origin of the vector.

It is also possible for a plurality of vectors that correspond to a plurality of statistically representative trends to be observed amongst the section of the reference population under consideration, all starting from one zone or one point on the plane in FIG. 5.

In FIG. 5, only three zones 16 to 18 are defined, which represent corresponding skin colors.

For example, for those individuals having color and hue that correspond to zone 17, all of said individuals generally wish to see the color change as represented by vector 17a, i.e. a decrease in clarity and an increase in red hue, and this can correspond to the desire to have a more tanned color.

For those individuals of the reference population that are associated with zone 16, a plurality of statistically representative trends are observed, represented by vectors 16a and 16b.

In order to build the database 13, for each reference population corresponding, for example, to the inhabitants of a given country, or of a region of said country, or even a more restricted geographical area such as the neighborhood in a town, a representative sample of said population is selected, and the skin color of said individuals can be measured and classified by skin color.

The various classes of observed skin colors, which, for example, correspond to various pairs of values of clarity and hue in the color chart that is used for the evaluation, are entered in a column 21 of a table 22, for example.

For each skin color class, the percentage of the population associated with said class is entered in another column 23 of the table 22, and the desired skin color(s) is/are entered in yet another column 24, for example.

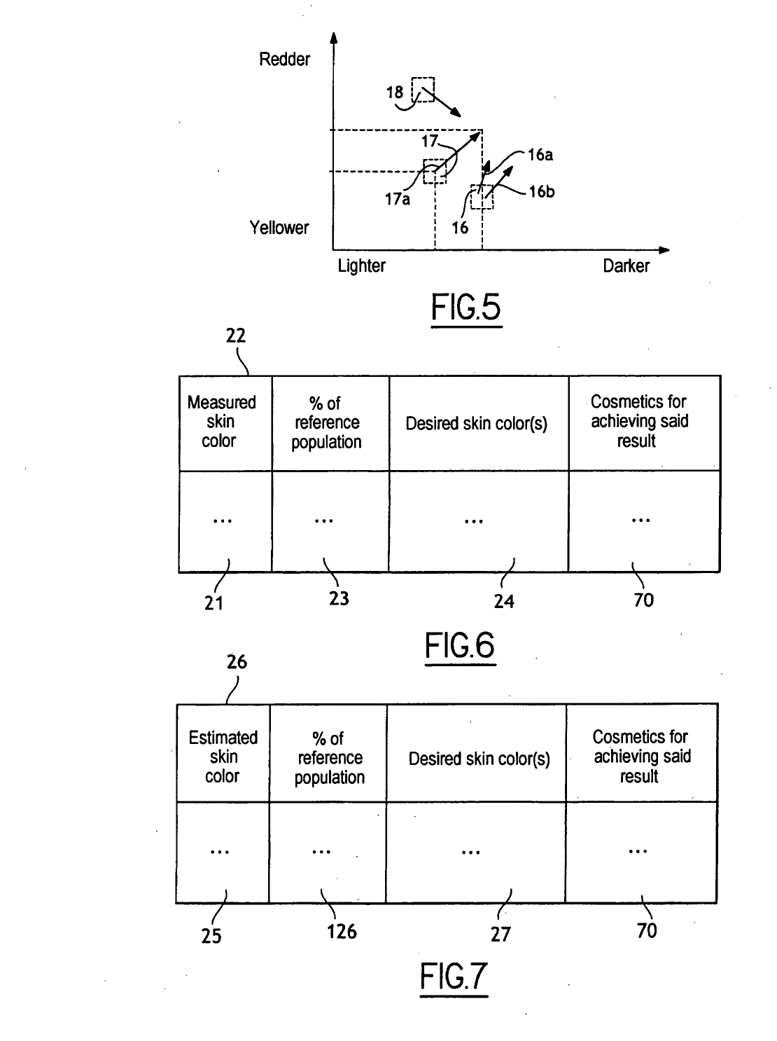

Table 26 in FIG. 7 differs from the table in FIG. 6 by the fact that the classes of measured skin color are replaced in column 25 by classes of skin colors that are estimated by the individuals of the reference population, the corresponding population percentage being entered in a column 126, and the desired skin color(s) in a column 27.

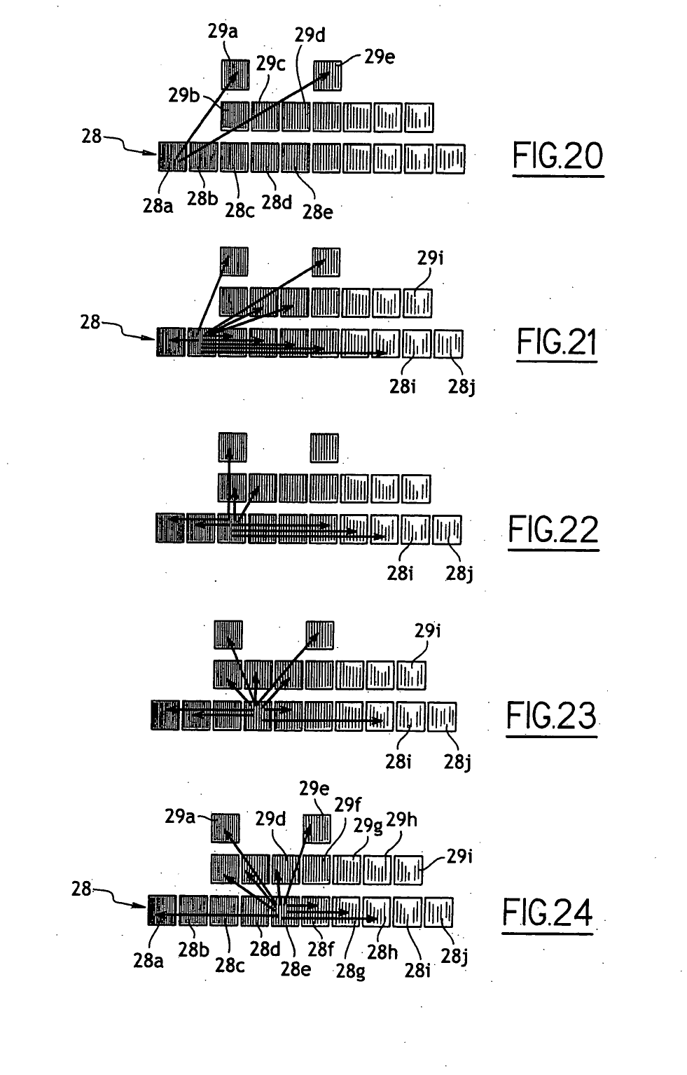

FIGS. 20 to 24 relate to another example, in the field of hair.

These figures show a scale 28 of natural hair colors 28a, 28b, . . . , and a set of unnatural colors 29a, 29b, . . . .

Arrows represent the color trends observed in a reference population.

Thus, in the example in FIG. 20, the color trends observed amongst those individuals having hair whose natural color is 28a, consist in obtaining artificial colors 29a and 29e, whereas in the examples in the other figures, trends can also be observed of the individuals seeking to obtain darker or lighter natural colors.

The corresponding data can be tabulated in a manner similar to that described above for the skin.

On examining FIGS. 20 to 24, it should also be observed that no trend is observed in the reference population of seeking to obtain the hair colors 28i and 28j that correspond to very light colors, for example, nor of seeking to obtain the unnatural colors 29g, 29h, and 29i.

Thus, the corresponding cosmetics have little chance of being purchased by consumers that are similar to the individuals under consideration in the reference population.

The range of cosmetics made available in stores frequented by such people could thus be limited solely to those cosmetics that correspond to the observed trends, thereby making it possible to reduce costs, in particular in terms of distribution costs.

The operation of the interactive system 1 in an implementation of the invention is described below, with reference once again to FIG. 4.

The computer program executed by the data management means can, in a step 30, instigate the acquisition of data relating to at least one appearance parameter of the user, i.e. skin color in the example under consideration.

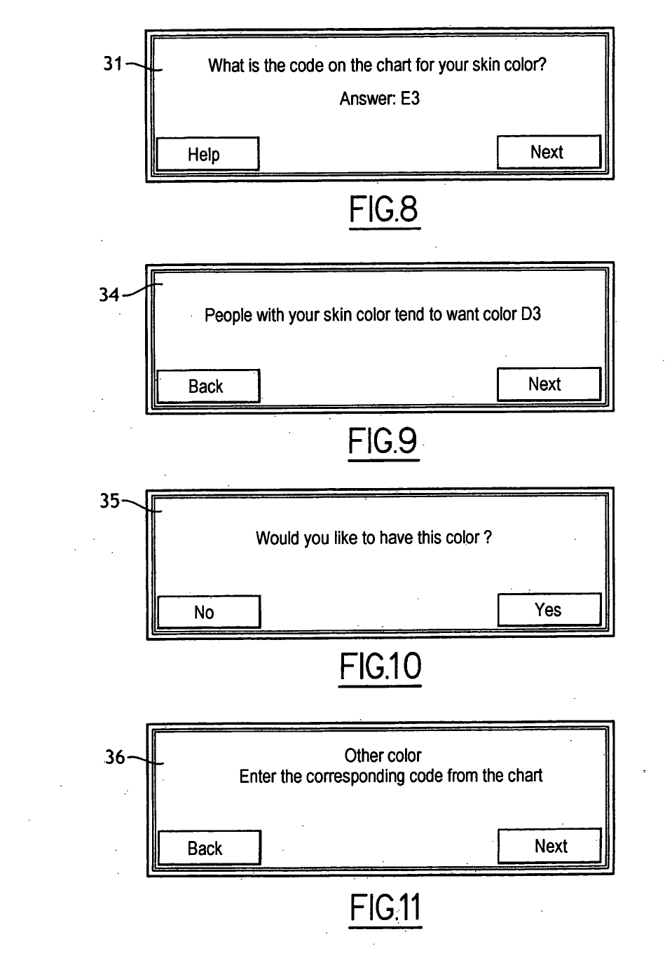

By way of example, the acquisition can be performed after a screen page 31 has been displayed, as shown in FIG. 8, asking the user to enter an identifier corresponding to the user's skin color, after examining the color chart 5.

By way of example, the identifier is a letter going from A to E depending on the hue of the skin color, followed by a number lying in the range 1 to 10 depending on the clarity of the skin.

After interrogating the database 13, which can, for example, contain data organized in the form of tables 6 or 7, or in some other form, the data management means can then, in a step 33, cause information to be displayed, informing the user about a trend observed in a reference population that corresponds, for example, to the inhabitants of the region, or of the country, in which the interactive system 1 is located.

By way of example, the information is sent to the user by displaying a screen page 34, as shown in FIG. 9.

In the reference population in the example under consideration, the majority of people having color corresponding to the identifier E3 wish to have color of the same clarity, but that is less yellow, and that corresponds to the identifier D3.

The data management means can then ask the user to confirm a desire to be recommended a cosmetic that seeks to obtain the skin color corresponding to the stated trend, namely the color D3, by displaying a screen page 35, as shown in FIG. 10.

If the user does not accept the recommendation, the data management means can cause a screen page 36 to be displayed, asking the user to enter the identifier corresponding to the desired color on the color chart, as shown in FIG. 11. The response of the user can be recorded and can serve to modify the database 13, where appropriate.

Then, in a step 40, the data management means analyze the response of the user, and, in a step 41, determine, as a function of said response, one or more cosmetics adapted to the choice of the user.

This determination can be performed by interrogating the database 13, in which commercially available cosmetics and the properties of said cosmetics, e.g. in terms of their effect on the clarity and the hue of the skin, can be tabulated.

In a variant, the screen page 34 can also suggest a plurality of colors, when multiple trends have been observed in the reference population for a common appearance characteristic.

In an additional column 70 of the tables in FIGS. 6 and 7, for example, the database 13 can, for each of the color classes of the reference population, identify one or more cosmetics that make it possible to achieve the desired color.

In a step 42, the data management means can display information relating to the recommended cosmetic(s).

By way of example, the information can be the trade reference of the cosmetic(s), appearing on a screen page 43, as shown in FIG. 12.

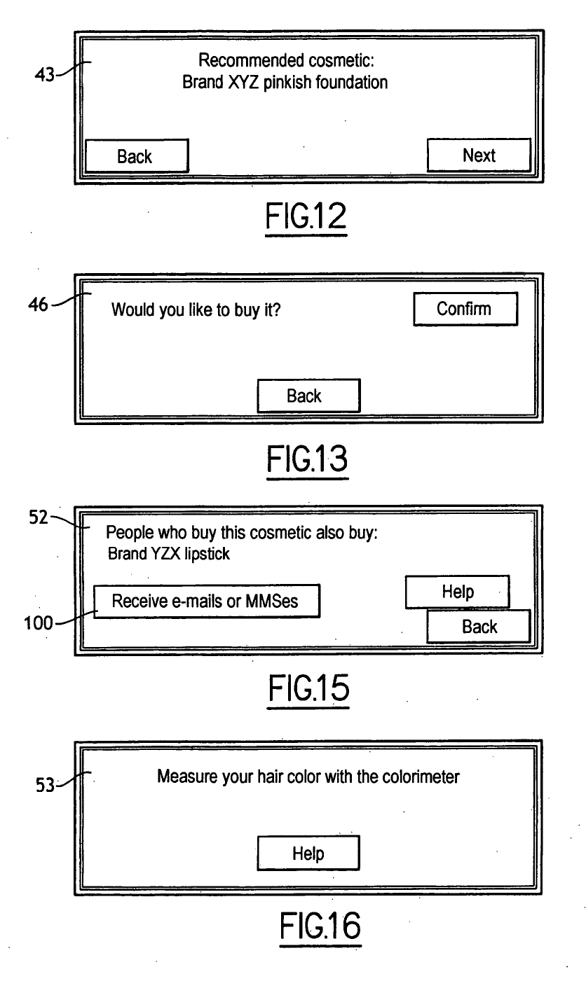

In an embodiment of the invention, the user can enter information that causes the interactive system 1 to issue an advice slip 6, such as the advice slip shown in FIG. 14, on which there appears the reference 48 of the cosmetic recommended by the interactive system 1, and, where appropriate, other information relating, for example, to the measured or estimated skin color.

The advice slip 6 can also contain information 49 that is useful for tracking the actions taken by the user once the advice has been delivered.

By way of example, the information 49 is in the form of an identifier, possibly one that is readable directly, and specifically a bar code in the example shown.

In the example in FIG. 4, the interactive system 1 is also arranged to record information relating to the purchase of the recommended cosmetic(s).

By way of example, it could record whether or not the user wishes to purchase the cosmetic, by displaying a screen page 46, as shown in FIG. 13.

When the method is implemented on a server of an Internet site to which the user is connected via a terminal, a positive response to the question posed on the screen page 46 can cause the cosmetic(s) concerned to be downloaded into a virtual shopping cart.

The interactive system 1 is advantageously arranged to record information relating to the cosmetic actually purchased by the user.

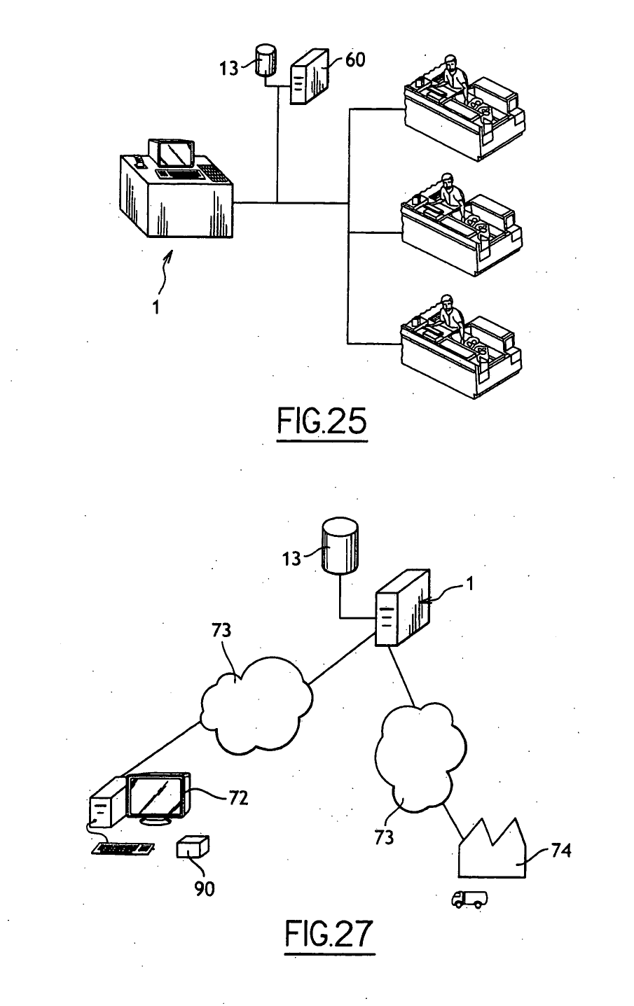

The additional information 49 that appears on the advice slip 6 can be used to this end, with said information being read at the cash desk, for example. By way of example, the cash desk can send information to a server 60 with which at least a part of the interactive system can also exchange data, as shown in FIG. 25.

Thus, a person who has used the interactive system 1 in a store and has received an advice slip 6 can, when at the cash desk, give in the slip 6, so that the information 49 present on said slip is read, thereby enabling the cosmetics actually purchased to be associated with data already entered in the interactive system 1, and thereby determining whether the user has indeed purchased the cosmetics that were recommended, for example. This also makes it possible to know which other cosmetics have been purchased.

The user can be encouraged by the store to use the advice slip 6 when at the cash desk, e.g. by making a promotion on the advised cosmetics conditional on presenting the slip 6 to the cashier.

The data collected in this way can be fed to the database 13, and when giving advice or recommending a cosmetic during the operation of the interactive system 1, it can serve, where appropriate, in a step 51, to enable additional information to be displayed, e.g. such as screen page 52 informing the user of the other cosmetics that are purchased by most consumers who have selected the cosmetic recommended by the interactive system, as shown in FIG. 15.

The interactive system 1 can also be arranged to enable the user to enter personal details, e.g. an e-mail address or a mobile-phone number, after clicking on a corresponding action button 100, so as to receive advertising, promotional, or informative messages, for example, at a later date.

Where appropriate, the interactive system 1 can be arranged to establish communication automatically with a mobile phone or the like, so as to simplify sending the personal details of the user to the interactive system 1, or so as to enable information corresponding to the information present on the advice slip 6 to be downloaded to the portable terminal of the consumer, thereby enabling the physical advice slip to be eliminated.

In the example in FIG. 8, it is the user who evaluates skin color.

When the interactive system 1 is fitted with a color-measuring device, the data management means can cause a screen page 53 to be displayed, as shown in FIG. 16, inviting the user to use the device.

The information sent by the user need not be restricted to one or more appearance characteristics, but can, for example, relate to other personal characteristics, e.g. such as the user's self-image, the user's preferred brands or cosmetics, or the user's tastes in music, cinema, or leisure.

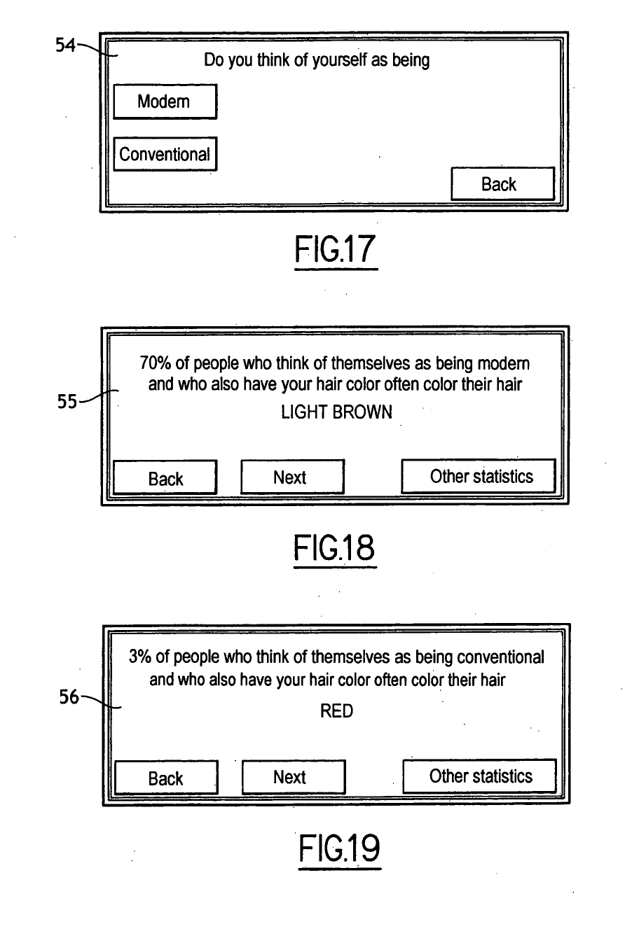

By way of example, the data management means can cause a screen page 54 to be displayed, as shown in FIG. 17, asking whether the user classifies himself or herself as being more or less old-fashioned or modern.

Where appropriate, the data collected in this way can be cross-checked with one or more appearance characteristics, and the data management means can, as shown in FIG. 18, deliver information in the form of a screen page 55 informing the user of a trend observed amongst the individuals of a reference population presenting personal characteristics similar to the personal characteristics of the user.

In the example in FIG. 18, the user is thus informed of the color(s) that is/are desired by most of those individuals of the reference population that have the same initial hair color and the same self-image as the user.

The statistical information stored in the-database does not necessarily relate to the trends observed amongst the majority of individuals in the reference population, and can, on the contrary, relate to a minority trend or to a histogram of trends. The corresponding information can be delivered to the user, e.g. by displaying a screen page 56, as shown in FIG. 19. In a variant, not shown, a histogram is displayed relating to a plurality of sections of the population, with the corresponding percentages and the preferred colors or cosmetics for each section.

Naturally, the invention is not limited to the embodiments described above.

In particular, as explained above and as shown in FIG. 27, the interactive system 1 can be arranged to exchange information with remote terminals 72, e.g. by means of a computer network 73 such as the Internet.

Where appropriate, the data management means can be shared between the server and a terminal connected to the server.

In order to enable on-line purchasing, the interactive system 1 can, where appropriate, send purchasing data to a logistics center 74 via the same computer network 73.

The user of a remote terminal 72 might have received an accessory or kit 90, e.g. containing a color chart, making it possible for the user to evaluate skin color or to measure said color by using an available video or digital camera. By way of example, the kit can thus include calorimetric calibration means for colorimetric calibration of the camera.

By way of example, the calorimetric calibration means are placed next to the skin while the image is being acquired.

When a plurality of users can be connected to a remote site, the data management means can be arranged to determine which reference population is to be considered for a given user. By way of example, the terminal of the user is geographically located by analyzing transmission parameters (computer address, configuration of the browser, name of the operator, triangulation by means of relays in a mobile-phone network or by satellite . . . ), and/or by analyzing responses to a questionnaire.

When the interactive system is present at a point of sale, the data management means can cause a questionnaire to be displayed, making it possible to determine more precisely the reference population to be considered.

FIG. 26 shows the possibility of formulating a personalized cosmetic by means of an automatic formulation system 91 disposed, for example, in the stand 2 of an interactive system similar to the interactive system described with reference to FIG. 1. By way of example, the formulation can be prepared as a function of the estimated or measured skin or hair color, and as a function of information resulting from interrogating the database 13.

Throughout the description, including in the claims, the expression “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An interactive system for advising at least one person, comprising:
acquisition means for acquiring at least one of an estimated appearance characteristic and a measured appearance characteristic of a person to be advised;
data management means configured to interrogate a database, the database comprising information relating to appearance characteristics desired by a reference population as a function of appearance characteristics at least one of estimated and measured amongst the individuals of the reference population; and
at least by interrogating the database, as a function of the at least one estimated or measured appearance characteristic; gather information from the database relative to a desired appearance characteristic desired by at least one section of the reference population,
means for sending information to the at least one person to be advised, said information at least one of relating to the desired appearance characteristic determined by the data management means and relating to at least one cosmetic for obtaining the desired appearance characteristic.

2. An interactive system according to claim 1, in which said section of the reference population comprises substantially the same appearance characteristic as the person to be advised.

3. An interactive system according to claim 1, wherein the acquisition means of the interactive system comprises at least one measuring device for measuring at least one of a physical, a chemical, and a biological characteristic of keratinous materials.

4. An interactive system according to claim 3, wherein the acquisition means of the interactive system comprises a measuring device for measuring the color of at least one of skin and hair.

5. An interactive system according to claim 1, wherein the acquisition means comprises a user interface.

6. An interactive system according to claim 1, wherein the means for sending information to the person to be advised comprises a display device.

7. An interactive system according to claim 1, further comprising at least one comparison element configured for evaluation of an appearance characteristic.

8. An interactive system according to claim 7, further comprising a color chart.

9. A system according to claim 8, wherein the color chart includes elements that substantially reproduce a reflectance spectrum of keratinous materials.

10. An interactive system according to claim 7, further comprising a hair-color chart.

11. An interactive system according to claim 1, wherein the data management means is configured to recommend at least one color to the user, the at least one color corresponding to appearance characteristics desired by the reference population, and wherein the interactive system is configured to enable the user to select the at least one color.

12. An interactive system according to claim 1, wherein the data management means is configured to recommend at least one cosmetic to the user, the at least one cosmetic serving to obtain a color corresponding to appearance characteristics desired by the reference population, and wherein the interactive system is configured to enable the user to select the at least one cosmetic.

13. An interactive system according to claim 1, further comprising recording means for recording data relating to cosmetics purchased by people who have used the interactive system.

14. An interactive system according to claim 1, wherein, as a function of at least one of a difference between an estimated appearance characteristic and a difference between a measured appearance characteristic of the person to be advised and the desired appearance characteristic corresponding to a trend observed in the reference population, the data management means of the interactive system being configured to determine at least one cosmetic to be applied.

15. An interactive system according to claim 1, further comprising issuing means for issuing an advice slip relating to a cosmetic recommended by the data management means.

16. An interactive system according to claim 15, wherein the system is configured to receive information that can be read at a cash desk, said information being on the advice slip, said information being associated with at least one reference for a cosmetic that has actually been purchased by the person.

17. An interactive system according to claim 1, the system being arranged to record the appearance characteristic desired by the user, at least one of before and after the person has been informed of the corresponding appearance characteristic desired by the reference population.

18. An interactive system according to claim 1, wherein the data management means and the acquisition means are geographically close together.

19. An interactive system according to claim 1, wherein the data management means and the acquisition means are geographically remote.

20. A system according to claim 19, wherein the information relating to the appearance characteristic acquired by the acquisition means is sent via a computer network to the data management means.

21. An interactive system according to claim 1, further comprising a means for formulating a personalized cosmetic.

22. A method for delivering an advice or a recommendation, the method comprising:
enabling an interactive system to acquire information relating to a personal characteristic of the person to be advised;
interrogating a database that lists trends related to cosmetics, observed in a reference population as a function of the personal characteristics of the individuals making up said reference population; and
as a function of the result of the interrogation, delivering, via the interactive system, information informing the user of a trend observed in the reference population for individuals of said reference population having a similar personal characteristic.

23. A method according to claim 22, wherein the personal characteristic comprises an appearance characteristic.

24. A method according to claim 23, wherein the appearance characteristic relates to a color of at least one of skin and hair.

25. A method according to claim 23, further comprising evaluating at least one of skin and hair color of the user by at least one of using a color chart and measuring the color using a measuring device.

26. A method of building a database, comprising:
recording for each individual of a reference population:
at least one personal characteristic; and
at least one desired appearance characteristic, and
statistically processing the recorded data, so as to reveal trends in desired appearance characteristics as a function of personal characteristics.

27. A method according to claim 26, wherein the personal characteristic comprises an appearance characteristic.

28. A method according to claim 26, wherein the desired appearance characteristic comprises at least one of a skin color and a hair color.

29. A method for delivering advice or a recommendation relating to a cosmetic for changing an appearance characteristic of a subject, comprising:
acquiring information that is representative of the appearance characteristic of the subject to be advised; and
delivering information that is representative of an appearance characteristic change that is desired by at least one section of a reference population.

30. A method according to claim 27, in which the appearance characteristic comprises a color of skin.

31. A method according to claim 27, in which the appearance characteristic comprises a color of hair.
